(19) United States
(12) Patent Application Publication
(10) Pub. No.: US 2015/0336594 A1
(43) Pub. Date: Nov. 26, 2015

(54) METHOD AND SYSTEM FOR CONTROLLING RADIO COMMUNICATION APPARATUS OF TRAIN, AND METHOD AND SYSTEM FOR REMOTELY MANAGING TRAIN

(71) Applicant: ELECTRONICS AND TELECOMMUNICATIONS RESEARCH INSTITUTE, Daejeon (KR)

(72) Inventors: Byungsik YOON, Daejeon (KR); Sook Jin LEE, Daejeon (KR); Yong Seouk CHOI, Daejeon (KR)

(73) Assignee: ELECTRONICS AND TELECOMMUNICATIONS RESEARCH INSTITUTE, Daejeon (KR)

(21) Appl. No.: 14/656,678

(22) Filed: Mar. 12, 2015

(30) Foreign Application Priority Data
May 26, 2014 (KR) 10-2014-0063290

(51) Int. Cl. B61L 15/00; H04B 17/309; H04B 17/15

(52) U.S. Cl. CPC B61L 15/0027; H04B 17/15; H04B 17/309

(57) ABSTRACT

A system that controls a train radio communication apparatus is provided. The control system periodically detects performance of each of a first train radio communication apparatus and a second train radio communication apparatus. The control system selects either one of the first train radio communication apparatus and the second train radio communication apparatus based on the detected performance. The control system transfers a signal that is received from the selected train radio communication apparatus.

### CROSS-REFERENCE TO RELATED APPLICATION

This application claims priority to and the benefit of Korean Patent Application No. 10-2014-0063290 filed in the Korean Intellectual Property Office on May 26, 2014, the entire contents of which are incorporated herein by reference.

### BACKGROUND OF THE INVENTION

(a) Field of the Invention

The present invention relates to a system and method that control radio communication of a train, and a method and system that remotely manage a train.

(b) Description of the Related Art

In a train system, because stability is a very important consideration, the train system is always formed in a dualization system (master system, slave system). Here, the master system operates upon initial driving of a train, and the slave system operates when a problem occurs in the master system.

Similarly, a radio communication system of the train is formed in a dualization system (master system, slave system). When a problem occurs in the master radio communication system, the master radio communication system is quickly converted to the slave radio communication system.

In order to form the train radio communication system in a dualization system or a triplication system, there is a problem that a configuration and a processing operation of an interface apparatus of a train system that is connected to the train radio communication apparatus should be changed.

### SUMMARY OF THE INVENTION

The present invention has been made in an effort to provide a method and apparatus having advantages of being capable of quickly implementing dualization of a train radio communication apparatus without a configuration change of a train system.

The present invention has been made in an effort to further provide a method and apparatus having advantages of being capable of remotely monitoring and controlling a control operation of a train radio communication apparatus.

The present invention has been made in an effort to further provide a method and apparatus having advantages of controlling a remote signal in a radio communication-based train control system.

An exemplary embodiment of the present invention provides a system that controls a train radio communication apparatus. The control system includes: a detection processor that periodically detects performance of each of a first train radio communication apparatus and a second train radio communication apparatus; and a selection processor that selects either one of the first train radio communication apparatus and the second train radio communication apparatus based on the detected performance and that transfers a signal that is received from the selected train radio communication apparatus.

Performance of each of the first and second train radio communication apparatuses may correspond to quality of a signal that is received from each of the first and second train radio communication apparatuses.

The detection processor may periodically request information for detecting performance of the first and second train radio communication apparatuses from the first and second train radio communication apparatuses.

The selection processor may periodically select either one of the first and second train radio communication apparatuses based on the periodically detected performance.

The control system may further include a first interface processor for interfacing with a train system that controls a train. The selection processor may transfer only a signal that is received from the selected train radio communication apparatus among signals that are received from the first and second train radio communication apparatuses to the first interface processor.

The control system may further include a second interface processor for interfacing with the first and second train radio communication apparatuses.

The second interface processor may include an Ethernet interface.

Another embodiment of the present invention provides a method in which a train radio communication control system controls radio communication in a train. The method includes: periodically detecting performance of each of at least two train radio communication apparatuses in a first mode; periodically selecting either one of the train radio communication apparatuses based on the detected performance; and transferring only a signal that is received from the selected train radio communication apparatus among signals that are received from the train radio communication apparatuses to a train system. The train system controls the train.

The periodically detecting performance may include: requesting information for detecting performance of the train radio communication apparatus from the train radio communication apparatuses; and detecting performance of each of the train radio communication apparatuses based on information that is received from each of the train radio communication apparatuses.

The method may further include transferring information regarding the selected train radio communication apparatus to a remote management system. The remote management system may remotely control the train.

The method may further include selecting either one of the train radio communication apparatuses based on a control signal that is received from a remote management system in a second mode.

The selecting of either one of the train radio communication apparatuses in a second mode may include: requesting first information for detecting performance of the train radio communication apparatuses from the train radio communication apparatuses in response to a performance information request that is received from the remote management system; and detecting performance of each of the train radio communication apparatuses based on the first information that is received from each of the train radio communication apparatuses and transmitting the detection result to the remote management system.

The control signal may be generated based on the detection result in the second mode.

The method may further include transferring information regarding the selected train radio communication apparatus in the second mode to the remote management system.

Yet another embodiment of the present invention provides a system that remotely manages a train. The system includes a controller that controls a control system within the train. The controller receives performance information of each of a first train radio communication apparatus and a second train radio communication apparatus within the train from the control system, and generates a control signal based on the received performance information to transmit the control signal to the control system. The control signal is a signal for selecting either one of the first and second train radio communication apparatuses.

The system may further include a first interface processor for interfacing with the control system. The first interface processor may receive the performance information from the control system and transfer the performance information to the controller.

The system may further include a second interface processor for interfacing with a user. The controller may generate the control signal based on user input through the second interface processor.

The system may further include a display processor that displays the received performance information on a screen. The first interface processor may receive a control result by the control signal from the control system. The display processor may display the control result on the screen.

### BRIEF DESCRIPTION OF THE DRAWINGS

FIG. 1 is a diagram illustrating a train radio communication control system and a remote management system according to an exemplary embodiment of the present invention.

FIG. 2 is a block diagram illustrating a configuration of the train radio communication control system of FIG. 1.

FIG. 3 is a block diagram illustrating a configuration of the remote management system of FIG. 1.

FIG. 4 is a flowchart illustrating a portion of a process of controlling train radio communication according to an exemplary embodiment of the present invention.

FIG. 5 is a flowchart illustrating another portion of a process of controlling train radio communication according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

A base station (BS) may indicate an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) that performs a function of the BS, and an HR-RS that performs a function of the BS, and may include an entire function or a partial function of the ABS, the node B, the eNodeB, the AP, the RAS, the BTS, the MMR-BS, the RS, and the HR-RS.

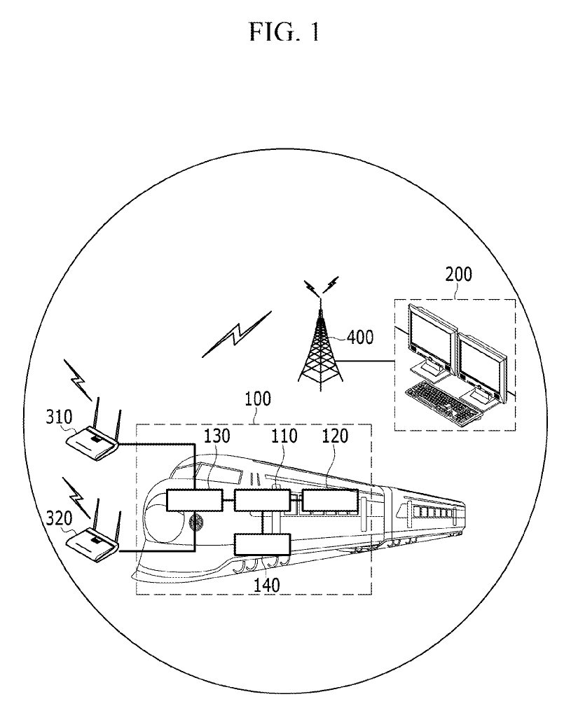

FIG. 1 is a diagram illustrating a train radio communication control system 100 and a remote management system 200 according to an exemplary embodiment of the present invention. FIG. 1 illustrates a case in which the train radio communication control system 100 and the remote management system 200 communicate through relay of a base station 400.

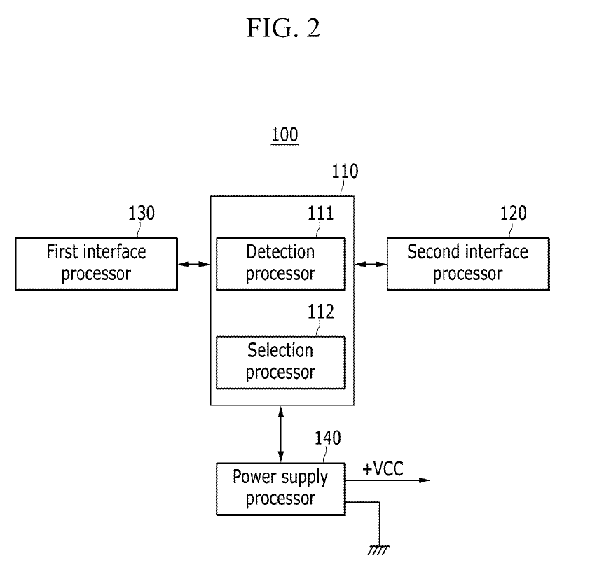

The train radio communication control system 100 is a system that controls at least one of train radio communication apparatuses 310 and 320. Here, the train radio communication apparatuses 310 and 320 are apparatuses for radio communication within a train, and may each be an Access Point (AP). For convenience of description, FIG. 1 illustrates a case in which there are two train radio communication apparatuses 310 and 320. Specifically, the train radio communication control system 100 may include a controller 110, a first interface processor 130, a second interface processor 120, and a power supply processor 140. Each configuration of the train radio communication control system 100 will be described in detail with reference to FIG. 2.

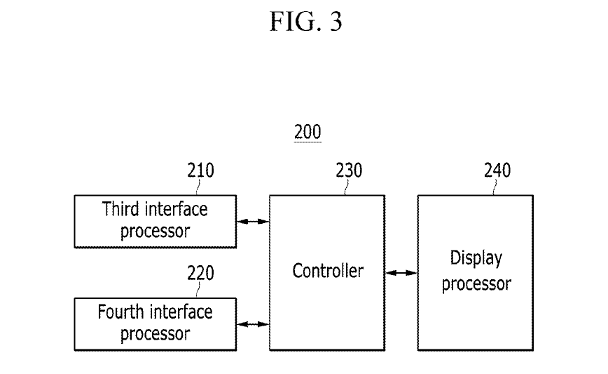

The remote management system 200 is a system that remotely manages and controls the train. Specifically, the remote management system 200 may include a third interface processor 210, a fourth interface processor 220, a controller 230, and a display processor 240. A configuration of the remote management system 200 will be described in detail with reference to FIG. 3.

FIG. 2 is a block diagram illustrating a configuration of the train radio communication control system 100 of FIG. 1.

The first interface processor 130 interfaces with the train radio communication apparatuses 310 and 320. Specifically, in order to receive information for performance detection from the train radio communication apparatuses 310 and 320, the first interface processor 130 may include an Ethernet interface. In order to measure a radio signal state of the train radio communication apparatuses 310 and 320, which are train apparatuses, the first interface processor 130 forms a protocol for data transfer with the train radio communication apparatuses 310 and 320.

The second interface processor 120 interfaces with a train system (not shown). The train system is a system for train control. Specifically, the second interface processor 120 may include an Ethernet interface for transmitting and receiving a signal with the train system. An interface configuration of the second interface processor 120 may be various according to an interface of the train system.

The controller 110 detects performance of the train radio communication apparatuses 310 and 320 and controls operation thereof. Performance of each of the train radio communication apparatuses 310 and 320 may be determined based on quality of a signal that is received from the train radio communication apparatuses 310 and 320 or a radio communication state thereof. Specifically, the controller 110 may be connected to the train radio communication apparatuses 310 and 320 through the first interface processor 130. The controller 110 may be connected to the train system through the second interface processor 120. The controller 110 may include a detection processor 111 and a selection processor 112.

The detection processor 111 detects performance of the train radio communication apparatuses 310 and 320. Specifically, the detection processor 111 may periodically detect signal quality of the train radio communication apparatuses 310 and 320. The detection processor 111 may detect performance of the train radio communication apparatuses 310 and 320 in response to a request of the remote management system 200.

The selection processor 112 may select either one of the train radio communication apparatuses 310 and 320 based on performance of each of the train radio communication apparatuses 310 and 320 that are detected by the detection processor 111. The selection processor 112 may transfer a signal that is received from the selected apparatus to the train system through the second interface processor 120. For example, when it is determined by the detection processor 111 that performance of the train radio communication apparatus 310 of the two train radio communication apparatuses 310 and 320 is better, the selection processor 112 may transfer a signal that is received from the train radio communication apparatus 310 to the train system and may not use a signal that is received from the remaining train radio communication apparatus 320. The selection processor 112 may control operation of the train radio communication apparatuses 310 and 320 in response to a control signal that is received from the remote management system 200. Specifically, the selection processor 112 may select either one of the train radio communication apparatuses 310 and 320 based on a control signal that is received from the remote management system 200. The selection processor 112 may transfer a signal that is received from the selected apparatus to the train system through the second interface processor 120.

The controller 110 may measure performance of the train radio communication apparatuses 310 and 320 in real-time or periodically and select a train radio communication apparatus having better performance among the train radio communication apparatuses 310 and 320 in real-time or periodically.

The power supply processor 140 supplies operation power (+VCC) to the controller 110, the second interface processor 120, or the first interface processor 130.

FIG. 3 is a block diagram illustrating a configuration of the remote management system 200 of FIG. 1.

The remote management system 200 remotely controls the train radio communication apparatuses 310 and 320. Specifically, by remotely accessing the train radio communication control system 100, the remote management system 200 controls the train radio communication apparatuses 310 and 320. The remote management system 200 receives an operation state of the controlled train radio communication apparatuses 310 and 320 from the train radio communication control system 100 to display the operation state on a screen.

The remote management system 200 may include a third interface processor 210, a fourth interface processor 220, a controller 230, and a display processor 240.

The third interface processor 210 interfaces with the train radio communication control system 100. Specifically, the third interface processor 210 may transfer a signal that is received from the train radio communication control system 100 to the controller 230 and transfer a signal that is received from the controller 230 to the train radio communication control system 100.

The fourth interface processor 220 interfaces with a user. Specifically, the fourth interface processor 220 transfers an input of the user to the controller 230. Here, the user input may be an instruction for controlling the train radio communication apparatuses 310 and 320.

The controller 230 remotely controls the train radio communication apparatuses 310 and 320. Specifically, the controller 230 receives performance information of the train radio communication apparatuses 310 and 320 from the train radio communication control system 100, and remotely controls the train radio communication apparatuses 310 and 320 based on the received performance information. For example, the controller 230 may generate a control signal for selecting a train radio communication apparatus having better performance among the train radio communication apparatuses 310 and 320 based on received performance information. The controller 230 processes a signal of the train radio communication control system 100 that is received through the third interface processor 210. The controller 230 may display the processed signal of the train radio communication control system 100 on a screen through the display processor 240. Further, the controller 230 may process a user input that is received from the fourth interface processor 220. The controller 230 may transfer a signal (e.g., a control signal) corresponding to a user input to the train radio communication control system 100 through the third interface processor 210.

The display processor 240 may display performance information of the train radio communication apparatuses 310 and 320 that is received from the train radio communication control system 100 on a screen. Further, the display processor 240 may receive a control result (an operation state or performance of the train radio communication apparatuses 310 and 320) of the train radio communication apparatuses 310 and 320 from the train radio communication control system 100 to display the control result on a screen.

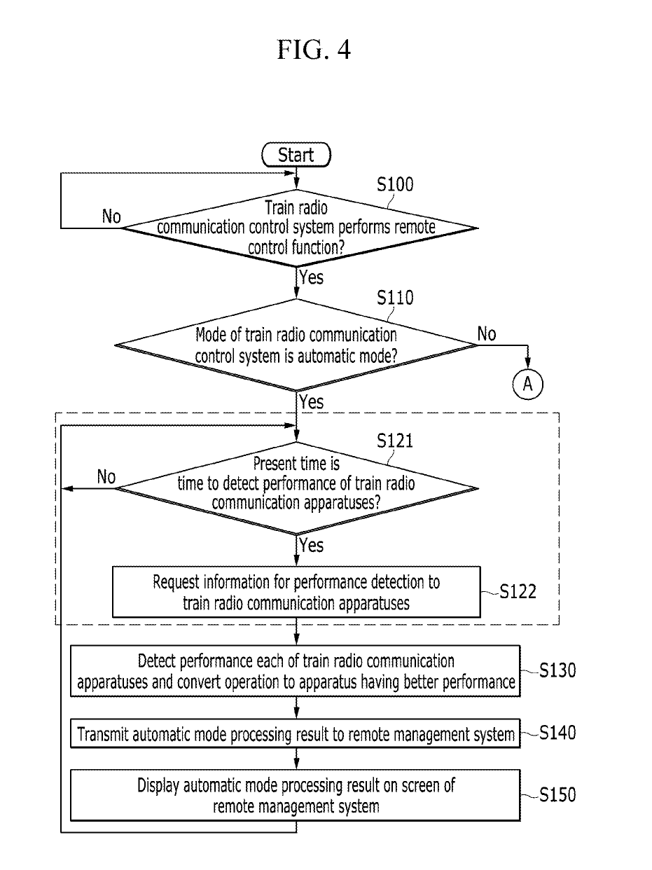

FIG. 4 is a flowchart illustrating a portion of a process of controlling train radio communication according to an exemplary embodiment of the present invention. Specifically, FIG. 4 illustrates a process in which the train radio communication control system 100 controls train radio communication when a mode of the train radio communication control system 100 is an automatic mode.

The train radio communication control system 100 determines whether the train radio communication control system 100 performs a remote control function (S100). Here, a remote control function may be set through the remote management system 200.

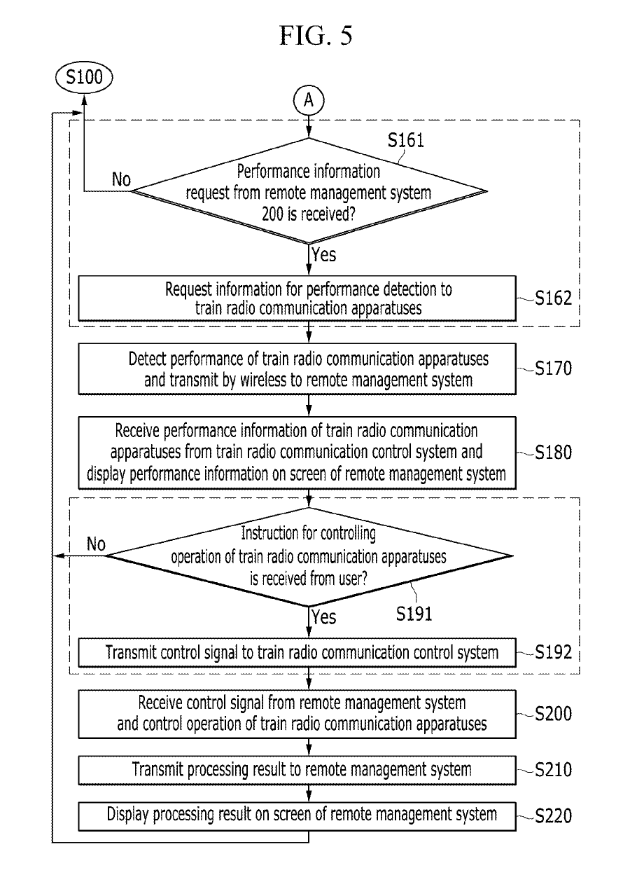

If the train radio communication control system 100 performs a remote control function, the train radio communication control system 100 determines whether a mode of the train radio communication control system 100 is an automatic mode (S110). Operation when a mode of the train radio communication control system 100 is a user control mode instead of an automatic mode will be described with reference to FIG. 5.

If a mode of the train radio communication control system 100 is an automatic mode, the train radio communication control system 100 determines whether a present time is a time (designated time) to detect performance (state) of the train radio communication apparatuses 310 and 320 (S121).

If a present time is a time to detect performance of the train radio communication apparatuses 310 and 320, the train radio communication control system 100 requests information (state information) for performance detection to the train radio communication apparatuses 310 and 320 through the first interface processor 130 (S122). Specifically, the train radio communication control system 100 may repeatedly request state information from the train radio communication apparatuses 310 and 320 for a predetermined time period by operating a timer. The remote management system 200 may change timer information related to a state information request of the train radio communication control system 100.

The train radio communication control system 100 detects performance each of the train radio communication apparatuses 310 and 320 based on information that is received from the train radio communication apparatuses 310 and 320 (S130). The train radio communication control system 100 converts operation to an apparatus having better performance among the train radio communication apparatuses 310 and 320 based on the detected performance information (S130). Only a signal that is received from an apparatus having better performance among the train radio communication apparatuses 310 and 320 is transferred to the train system, and a signal that is received from the remaining apparatus is not used.

The train radio communication control system 100 transmits an automatic mode processing result (automatic mode processing state) of S130 to the remote management system 200 (S140).

The remote management system 200 displays an automatic mode processing result (operation state of each of the train radio communication apparatuses 310 and 320) that is received from the train radio communication control system 100 on a screen (S150).

FIG. 5 is a flowchart illustrating another portion of a process of controlling train radio communication according to an exemplary embodiment of the present invention. Specifically, FIG. 5 illustrates a process of controlling train radio communication of the remote management system 200 and the train radio communication control system 100 when a mode of the train radio communication control system 100 is a user control mode.

When a user wants performance information of the train radio communication apparatuses 310 and 320, the remote management system 200 requests performance information of the train radio communication apparatuses 310 and 320 from the train radio communication control system 100.

The train radio communication control system 100 determines whether a performance information request (an operation state request) from the remote management system 200 is received (S161), and if a performance information request from the remote management system 200 is received, the train radio communication control system 100 requests information for performance detection from the train radio communication apparatuses 310 and 320 in response to the request of the remote management system 200 (S162). The train radio communication control system 100 detects performance (or operation state) of each of the train radio communication apparatuses 310 and 320 based on information that is received from the train radio communication apparatuses 310 and 320, and wirelessly transmits detected performance information to the remote management system 200 (S170).

The remote management system 200 receives performance information of each of the train radio communication apparatuses 310 and 320 from the train radio communication control system 100 and displays the performance information on a screen (S180). The user may monitor performance of each of the train radio communication apparatuses 310 and 320 through performance information that is displayed on a screen. The user may monitor performance of the train radio communication apparatuses 310 and 320 and input an instruction for controlling operation of the train radio communication apparatuses 310 and 320.

The remote management system 200 determines whether an instruction for controlling operation of the train radio communication apparatuses 310 and 320 is received from the user (S191), and if an instruction for controlling operation of the train radio communication apparatuses 310 and 320 is received from the user, the remote management system 200 generates a control signal corresponding to the user input (or instruction) and transmits the control signal to the train radio communication control system 100 (S192).

The train radio communication control system 100 receives the control signal from the remote management system 200, and controls operation of the train radio communication apparatuses 310 and 320 in response to the control signal that is received from the remote management system 200 (S200). Specifically, the train radio communication control system 100 may select either one of the train radio communication apparatuses 310 and 320 in response to the control signal and transfer only a signal that is received from the selected apparatus to the train system.

The train radio communication control system 100 transmits a processing result (operation state of each of the train radio communication apparatuses 310 and 320) of S200 to the remote management system 200 through the first interface processor 130 (S210).

The remote management system 200 displays the processing result (operation state of each of the train radio communication apparatuses 310 and 320) that is received from the train radio communication control system 100 on a screen (S220).

Therefore, according to an exemplary embodiment of the present invention, the user can monitor an operation state of each of the train radio communication apparatuses 310 and 320 through the remote management system 200 that is installed at a remote location and control operation of each of the train radio communication apparatuses 310 and 320 at a remote location based on a monitoring result. Thereby, quality of a train radio communication service can be improved through dualization of the train radio communication apparatuses 310 and 320.

According to an exemplary embodiment of the present invention, operation conversion between dualized train radio communication apparatuses can be automatically or remotely controlled. Further, according to an exemplary embodiment of the present invention, an operation state of a dualized train radio communication apparatus can be monitored. Specifically, a control system according to an exemplary embodiment of the present invention is located between an interface of a dualized train radio communication apparatus and an interface of a train system, and performance of the train radio communication apparatus is monitored without additional operation processing of the train system and thus operation conversion to an apparatus having better performance can be automatically performed. Further, according to an exemplary embodiment of the present invention, by communicating with a control system at a remote location, a state of each train radio communication apparatus is monitored and thus a user can control operation conversion of the train radio communication apparatus at a remote location.

Further, according to an exemplary embodiment of the present invention, a radio signal state according to a radio signal environment of a train radio communication equipment is measured, a train radio communication apparatus having better performance is selected, and by providing train radio communication through the selected train radio communication apparatus, damage to the train radio communication apparatus can be preemptively prevented, stability of train radio communication and stability of train control can be guaranteed, and a QoS of train radio communication can be improved.

Further, according to an exemplary embodiment of the present invention, by comparing performance of a plurality of train radio communication apparatuses in real-time and by selecting an apparatus having optimal performance in real-time, a signal for train control can be more reliably transmitted and received. Conventionally, when a radio link of a master radio communication apparatus of a dualized train radio communication apparatus is not disconnected, even if a radio communication state is not good, the master radio communication apparatus continuously performs communication. Thereby, performance degradation (delay time increase, throughput reduction, and radio link failure) can occur. However, according to an exemplary embodiment of the present invention, by changing to a train radio communication apparatus having optimal performance in real-time, optimal radio link performance can be continuously maintained.

Further, according to an exemplary embodiment of the present invention, by measuring a radio signal state of a train radio communication apparatus in real-time and by using a radio signal having an optimal state, in radio communication-based train control, a probability of a fatal radio link failure can be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system that controls a train radio communication apparatus, the system comprising:
a detection processor that periodically detects performance of each of a first train radio communication apparatus and a second train radio communication apparatus; and
a selection processor that selects either one of the first train radio communication apparatus and the second train radio communication apparatus based on the detected performance and that transfers a signal that is received from the selected train radio communication apparatus.

2. The system of claim 1, wherein performance of each of the first and second train radio communication apparatuses corresponds to a quality of a signal that is received from each of the first and second train radio communication apparatuses.

3. The system of claim 2, wherein the detection processor periodically requests information for detecting performance of the first and second train radio communication apparatuses from the first and second train radio communication apparatuses.

4. The system of claim 3, wherein the selection processor periodically selects either one of the first and second train radio communication apparatuses based on the periodically detected performance.

5. The system of claim 4, further comprising a first interface processor for interfacing with a train system that controls a train,
wherein the selection processor transfers only a signal that is received from the selected train radio communication apparatus among signals that are received from the first and second train radio communication apparatuses to the first interface processor.

6. The system of claim 5, further comprising a second interface processor for interfacing with the first and second train radio communication apparatuses.

7. The system of claim 6, wherein the second interface processor comprises an Ethernet interface.

8. A method in which a train radio communication control system controls radio communication in a train, the method comprising:
periodically detecting performance of each of at least two train radio communication apparatuses in a first mode;
periodically selecting either one of the train radio communication apparatuses based on the detected performance; and
transferring only a signal that is received from the selected train radio communication apparatus among signals that are received from the train radio communication apparatuses to a train system that controls the train.

9. The method of claim 8, wherein the periodically detecting performance comprises:
requesting information for detecting performance of the train radio communication apparatus from the train radio communication apparatuses; and
detecting performance of each of the train radio communication apparatuses based on information that is received from each of the train radio communication apparatuses.

10. The method of claim 9, further comprising transferring information regarding the selected train radio communication apparatus to a remote management system,
wherein the remote management system remotely controls the train.

11. The method of claim 8, further comprising selecting either one of the train radio communication apparatuses based on a control signal that is received from a remote management system in a second mode,
wherein the remote management system remotely controls the train.

12. The method of claim 11, wherein the selecting of either one of the train radio communication apparatuses in a second mode comprises:
requesting first information for detecting performance of the train radio communication apparatuses from the train radio communication apparatuses in response to a performance information request that is received from the remote management system;
detecting performance of each of the train radio communication apparatuses based on the first information that is received from each of the train radio communication apparatuses; and
transmitting the detection result to the remote management system.

13. The method of claim 12, wherein the control signal is generated based on the detection result in the second mode.

14. The method of claim 13, further comprising transferring information regarding the selected train radio communication apparatus in the second mode to the remote management system.

15. The method of claim 8, wherein performance of each of the train radio communication apparatuses corresponds to quality of a signal that is received from each of the train radio communication apparatuses.

16. A system that remotely manages a train, the system comprising
a controller that controls a control system within the train,
wherein the controller receives performance information of each of a first train radio communication apparatus and a second train radio communication apparatus within the train from the control system and generates a control signal based on the received performance information to transmit the control signal to the control system, and
the control signal is a signal for selecting either one of the first and second train radio communication apparatuses.

17. The system of claim 16, wherein a performance of each of the first and second train radio communication apparatuses corresponds to a signal quality of each of the first and second train radio communication apparatuses.

18. The system of claim 17, further comprising a first interface processor for interfacing with the control system,
wherein the first interface processor receives the performance information from the control system and transfers the performance information to the controller.

19. The system of claim 18, further comprising a second interface processor for interfacing with a user,
wherein the controller generates the control signal based on user input through the second interface processor.

20. The system of claim 19, further comprising a display processor that displays the received performance information on a screen,
wherein the first interface processor receives a control result by the control signal from the control system, and
the display processor displays the control result on the screen.
